(19) United States
(12) Patent Application Publication
(10) Pub. No.: US 2026/0181017 A1
(43) Pub. Date: Jun. 25, 2026

(54) AI-BASED PHISHING SIMULATION SYSTEM AND METHOD OF OPERATION

(71) Applicant: Musarubra US LLC, Plano, TX (US)

(72) Inventors: Lili Ana, Austin, TX (US); Abhishek Kumar, Milpitas, CA (US); Kei Ozaki, Milpitas, CA (US); Nathan Lewis, Leander, TX (US); John Fokker, Amsterdam (NL); Rahul Iyer, Kildare (IE); Harold Rivas, Parker, TX (US); Gareth MacLachlan, Great Falls, VA (US)

(21) Appl. No.: 19/412,658

(22) Filed: Dec. 8, 2025

Related U.S. Application Data
(60) Provisional application No. 63/737,576, filed on Dec. 20, 2024.

(51) Int. Cl. H04L 9/40; G06N 20/00; G06Q 10/0631

(52) U.S. Cl. CPC H04L 63/1483; G06Q 10/063112; G06N 20/00

(57) ABSTRACT

A network device is described. The network device features a processor and a non-transitory storage medium. The non-transitory storage medium comprises multiple modules. A first module is configured, upon execution by the processor, to obtain content associated with environment assets situated within a first enterprise environment. A second module may include a campaign source module, which is configured, upon execution by the processor, to obtain content associated with phishing campaigns performed locally within the first enterprise environment and globally within one or more enterprise environments. A third module may include a template creation module, which is configured, upon execution by the processor, to generate a request message, including at least a portion of the content associated with the environment assets and the content associated with the phishing campaigns, for transmission to generative AI logic adapted to create and return one or more training templates customized for the first enterprise environment.

### FIELD

Embodiments of the disclosure generally relate to the field of cybersecurity. More specifically, one embodiment of the disclosure is related to an automated, phishing simulation system that leverages artificial intelligence (AI) to develop phishing templates for use in conducting simulated phishing attacks to determine vulnerabilities and train users within an enterprise to better identify phishing attacks.

### GENERAL BACKGROUND

Malware detection is the process of identifying and mitigating malicious or anomalous software, referred to as malware, which poses a threat to computer systems, networks, and data. Malware detection involves various techniques and tools designed to recognize the presence of malware or suspicious activities that may indicate an ongoing cybersecurity attack (hereinafter, “cyberattack”). One type of cyberattack, referred to as “phishing” or a “phishing attack,” normally involves electronic mail (email) messages that attempt to trick individuals or organizations into revealing sensitive information, such as login credentials, financial data, or personal information for example.

In particular, phishing email messages are typically designed to appear as though they are from a trusted source (e.g., a legitimate company or a recognized person within the company, government agency, or financial institution), rely on a recipient's inability to identify the phishing attack, and thereby manipulate the recipient into taking a specific action. Often, this specific action involves clicking on a link or downloading an attachment, which would lead to various nefarious activities, such as secretly installing software to exfiltrate information from the recipient's computer to commit identity theft, financial fraud, or further spread malware to other computers. To combat phishing attacks, it is important to educate company employees to identify this type of cyberattack through phishing simulation (e.g., a series of phishing email messages representing a phishing campaign by a malicious actor).

Unfortunately, conventional phishing simulation tools are unable to create effective training templates, namely email message templates from which security administrators can modify to initiate a simulated phishing attack. Rather, conventional phishing simulation tools rely on security administrators to manually search over publicly available networks for generic training templates for use in phishing simulations. Given that most of the uncovered training templates tend to be irrelevant to the company's environment that is undergoing employee testing, the security administrators spend a considerable amount of time sorting through a vast number of phishing templates that cannot be used. Additionally, to perform role-based or rank-based phishing attacks, the security administrator would need to single-handedly identify individuals in particular departments or with particular roles or titles with the targeted company, where such information is not publicly or easily available.

In summary, these manual activities, currently performed by security administrators utilizing conventional phishing simulation tools, are an inefficient use of company resources. Also, these manual activities tend to produce phishing simulations that are less helpful in assisting company employees to better identify phishing email messages because security administrators are not fully informed as to the operations or order of operations currently being performed by different employees within the company's environment and training templates are not configured in accordance with these operations or order of operations.

For example, security administrators commonly have no intricate knowledge of work patterns and email tendencies for different departments, groups, or employees operating within a company's environment in order to formulate simulated phishing email messages that may be more realistic to actual phishing email messages that may be received by employees during specific time periods.

Currently, there are no phishing simulation tools that (i) address the above-identified phishing knowledge gap between security administrator and the company environment and generates, through the assisting of generative artificial intelligence (AI) logic, training templates relevant to a selected company and inclusive of content that replicates role-based, rank-based, and/or risk-based cyberattacks.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1A is a block diagram illustrating the networked environment having a first configuration of network components and logic configured to perform phishing simulation using generative AI in accordance with some embodiments;

FIG. 1B is a block diagram illustrating the networked environment of FIG. 1A having a second, alternative configuration of network components and logic configured to perform phishing simulation using generative AI in accordance with some embodiments;

FIG. 2 is a block diagram illustrating logic of a computing system configured with AI-based phishing simulation logic deployed within either configuration of the networked environment of FIGS. 1A-1B in accordance with some embodiments;

FIG. 3 is a flowchart diagram illustrating operations conducted by the AI-based phishing simulation logic of FIG. 2;

FIG. 4 is a graphic user interface (GUI) illustrating operations in creation of a phishing simulation in accordance with some embodiments;

FIG. 5 is a graphic user interface (GUI) illustrating AI-based, phishing simulation in accordance with some embodiments;

FIG. 6 is a graphic user interface (GUI) illustrating a dashboard for illustrating results of the AI-based phishing simulation in accordance with some embodiments.

### DETAILED DESCRIPTION

An embodiment of the disclosure is directed to a system adapted with phishing simulation logic configured to generate customized, cyberattack (phishing) training templates for a targeted enterprise (e.g., company, partnership, co-op, agency including a governmental or private agency, venture, etc.). For testing of a specific enterprise environment, which may feature a plurality of network devices in communication over a network and operated by multiple network users (e.g., employees, contractors, interns, volunteers, etc.) for example, the phishing simulation system is configured to generate a prompt inclusive of content associated with the enterprise environment and provide the prompt to generative artificial intelligence (AI) logic (e.g., large language models “LLMs,” machine-learning “ML” models, etc.). Upon receipt of the prompt, the generative AI logic is configured to generate and return one or more enterprise-specific training templates for use in phishing simulations for that enterprise.

As described above, an enterprise environment features a networked environment featuring a plurality of network devices utilized by multiple network users or a single network user. Where the enterprise environment is directed to network devices associated with multiple network users, the “enterprise content” may include, but is not limited or restricted to the following: (1) content associated with enterprise environment assets, (2) content pertaining to network users associated with the enterprise, (3) content from prior attempted cyberattacks within the enterprise (e.g., content from detected phishing emails detected by one or more enterprise-based sensors) and/or (4) global threat intelligence including content pertaining to attempted cyberattacks collected by one or more sensors across one or more other enterprises. Similarly, where the enterprise is an individual, the content is associated with the individual's network device(s), the content associated with the individual herself or himself, the content from prior attempted cyberattacks against her/his network device(s), and/or the global threat intelligence as described above. For clarity sake, embodiments of the phishing simulation system will be deployed within an enterprise environment featuring multiple network users and multiple network devices.

As descried in detail below, the training templates operate as a basis for enterprise-specific phishing simulation. For example, the training template may correspond to an email message template for phishing simulation messages, which may encompass the latest phishing attack techniques within geographical or industrial sectors occupied to the enterprise. Security administrators can utilize the training templates to generate phishing simulation messages to a targeted group within the enterprise environment with granularity to capture role-based phishing simulation, rank-based (title-based) simulation or other group-based simulation.

According to one embodiment of the disclosure, the phishing simulation system is configured to conduct operations to identify and gather information associated with enterprise environment assets, such as the software and/or hardware utilized by the enterprise (e.g., network devices operating as part of an enterprise environment). The information may include the type of software installed within the enterprise environment, where the granularity of the information may vary depending on the enterprise. As an illustrative example, the gathered information may range from information associated with software and/or hardware utilized by the enterprise at large to information associated with software and/or hardware utilized by certain departments or particular network users of the enterprise. The aggregate of the gathered information may be stored as part of an enterprise profile.

Additionally, the gathered information (being stored as part of the enterprise profile) may include information associated with one or more network users of the enterprise environment, which also may be maintained as individual profiles or segregated by one or more defined, specific group profiles (e.g., department-based profiles; role-based profiles such as C-suite executives, managers or secretarial assistants, title-based segregation, and/or vulnerable users having a behavioral history of failing one or more phishing simulations). Furthermore, the gathered information may include information associated with phishing simulations attempted within the enterprise environment and globally detected across a wider range of enterprises or other entities.

Having access to the above-identified enterprise content inclusive of information directed to the enterprise environment assets, profile information, and information directed to prior or on-going phishing campaigns, the phishing simulation system utilizes generative AI logic to automatically create one or more training templates, which forms the basis for simulated phishing messages with relevant content to replicate role-based, rank-based, and/or risk-based phishing attacks.

More specifically, the phishing simulation system may generate prompts requesting training templates that take into account information associated with enterprise environment assets and/or prior detected or on-going phishing attacks. The phishing simulation system may be further configured to operate with the generative AI logic to further refine the training templates to target (i) certain groups within the enterprise environment (e.g., specific division, department, or team within the targeted enterprise), (ii) certain users having a particular role within the enterprise, and/or (iii) certain users determined, based on prior phishing simulations, to have a higher risk of vulnerability.

According to one embodiment of the disclosure, implemented as part of the phishing simulation system, the phishing simulation logic may be configured with some or all of the following modules: (1) enterprise environment discovery module, (2) campaign sources module, (3) template creation module, (4) template selection module, (5) user selection module, (6) template publishing module, and/or (7) monitor and learning module. General descriptions of these modules in accordance with at least one embodiment of the disclosure are provided below.

The enterprise environment discovery (EED) module is configured to discover enterprise assets (e.g., hardware type, installed software such as operating system type and/or version, software tool types, etc.). The information associated with the discovered enterprise assets assists the phishing simulation logic in selecting and customizing phishing simulations for a specific enterprise.

The campaign sources (CS) module is configured to identify phishing simulations operating in a global environment that are relevant to the enterprise. For example, two basic types of campaign sources may include (a) phishing campaigns observed in the enterprise environment and (b) phishing campaigns observed globally (outside the enterprise). According to one embodiment of the disclosure, the information associated with phishing campaigns observed in the enterprise environment may be captured by an email security system installed within the enterprise. The information associated with global phishing campaigns may be sorted by industry, geographical location, language, tool, and/or uncovered phishing techniques.

The template creation (TC) module is configured to operate with the generative AI logic to utilize content associated with a phishing campaign to create a usable template. According to one embodiment of the disclosure, the TC module may be configured to (i) remove all personally identifiable information (PII) data and “non-usable” data from the phishing campaign and/or (ii) add data associated with a specific enterprise environment or specific user profile to which the phishing simulation would be targeted (e.g., departmental role such as Human Resources (HR), Finance, Information Technology (IT), or the like).

The template selection (TS) module is configured to access the data from the EED module to automatically select a simulated cyberattack campaign (e.g., a phishing simulation) for an enterprise based on the enterprise environment. This event-driven module may be directed to conducting analytics on specific events that occur over time, such as a finance deals-related campaign at the end of a sales period or a gift cards-related campaign during the holiday season. The results of the analytics may be used to alter the content of the training template towards a specific event uncovered by the analytics.

The user selection (US) module is configured to restrict the transmission of simulated phishing messages to direct the phishing simulation to particular user or group of users. The determining of the particular user or group of users may be AI-driven and based on several factors, such as user role, organization, and behavioral history (e.g., information gathered from the email security system such as the number of spam emails received by the user, the number of quarantined emails for a user, earlier phishing campaign results for the user, etc.).

The template publishing (TP) module is configured to generate a customized simulated phishing template available to an enterprise for phishing simulations.

Lastly, the monitor and learning (M&L) module is configured to generate education materials to assist network users to better identify phishing attacks and reinforce enterprise procedures. For example, according to one embodiment, the education materials may include a web page accessible by the network user or a message sent to the network user with uniform resource locator (URL) link that, upon selection, retrieves the web page. The education material may include content to guide the network user through different aspects related to her or his failed phishing simulation and what to look for when a suspicious email message is received in the future. According to another embodiment of the disclosure, the education materials may include a calendar invite for the user to attend a mandatory training session or review certain security training materials.

The M&L module may be further configured to provide metrics associated with the phishing simulation such as success rate, failure rate, and/or hit rate (merely opening the simulated phishing message), which are made available to the security administrator. Additionally, the M&L module may be configured to provide content to train the generative AI logic for subsequent campaign templates that may include aspects of phishing simulations with higher failure rates.

### I. Terminology

In the following description, certain terminology is used to describe features of the invention. For example, in certain situations, the terms “component,” “module,” and “logic” are representative of hardware, firmware or software that is configured to perform one or more functions. As hardware, a component (or module or logic) may include circuitry having data processing or storage functionality. Examples of such circuitry may include, but are not limited or restricted to, a hardware processor (e.g., microprocessor with one or more processor cores, a digital signal processor, a programmable gate array, a microcontroller, an application specific integrated circuit “ASIC,” etc.), a semiconductor memory, or combinatorial elements.

A component (or module or logic) may be software in the form of a process or one or more software modules, such as executable code in the form of an executable application, an API, a routine or subroutine, a function, a procedure, an applet, a servlet, source code, object code, a shared library/dynamic load library, or one or more instructions or commands. These software modules may be stored in any type of a suitable non-transitory storage medium, or transitory storage medium (e.g., electrical, optical, acoustical, or other form of propagated signals such as carrier waves, infrared signals, or digital signals). The non-transitory storage medium may correspond to physical storage which, in some cases, may be represented as virtual storage with underlying physical storage. Examples of non-transitory storage medium may include, but are not limited or restricted to a programmable circuit; semiconductor memory corresponding to non-persistent storage such as volatile memory (e.g., any type of random access memory “RAM”) or persistent storage such as non-volatile memory (e.g., read-only memory “ROM”, power-backed RAM, flash memory, phase-change memory, etc.); drive technology such as a solid-state drive, hard disk drive, or an optical disc drive; and/or a portable memory device. As firmware, the executable code may be stored in persistent storage. Upon execution of an instance of a system component or a software module, a “process” performs operations as coded by the software component.

According to one embodiment, the term “malware” may be construed broadly as any code or activity that initiates a malicious attack and/or operations associated with anomalous or unwanted behavior. For instance, malware may correspond to a type of malicious computer code that executes an exploit to take advantage of a vulnerability, for example, to harm or co-opt operation of a network device or misappropriate, modify, or delete data. Malware may also correspond to an exploit, namely information (e.g., executable code, data, command(s), etc.) that attempts to take advantage of a vulnerability in software and/or an action by a person gaining unauthorized access to one or more areas of a network device to cause the network device to experience undesirable or anomalous behaviors. The undesirable or anomalous behaviors may include a communication-based anomaly or an execution-based anomaly, which, for example, could (1) alter the functionality of the network device executing application software in an atypical manner (a file is opened by a first process where the file is configured to be opened by a second process and not the first process); (2) alter the functionality of the network device executing that application software without any malicious intent; and/or (3) provide unwanted functionality which may be generally acceptable in another context.

The term “sensor” may be generally construed as a physical or virtualized device with data processing capability and/or a capability of connecting to a network, such as a public cloud network (e.g., Amazon Web Service (AWS®), Microsoft Azure®, Google Cloud®, etc.), a private cloud network, or any other network type. The sensor may be used by a component such as an email security system adapted to monitor email message received by, exchanged within, and sent out from the network. Examples of a sensor may include but are not limited or restricted to a software instance with message monitoring functionality, certain network devices with message monitoring functionality. The sensor, deployed as part any physical or virtualized device, may be communicatively coupled via an interface of the email security system (e.g., API(s)).

The term “network device” should be generally construed as electronics with the data processing capability and/or a capability of connecting to any type of network, such as a public network (e.g., Internet), a private network (e.g., a wireless data telecommunication network, a local area network “LAN”, etc.), or a combination of networks. Examples of a network device may include, but are not limited or restricted to, the following: an endpoint device (e.g., a laptop, a smartphone, a tablet, a desktop computer, a netbook, a medical device, or any general-purpose or special-purpose, user-controlled electronic device configured to support virtualization); a server; a mainframe; a router; or a security appliance that includes any system or subsystem configured to perform functions associated with malware detection and may be communicatively coupled to a network to intercept data routed to or from an endpoint device.

The term “message” generally refers to information transmitted in a prescribed format, where each message may be in the form of one or more packets or frames, a Hypertext Transfer Protocol (HTTP) based transmission, or any other series of bits having the prescribed format. For instance, a message may include an electronic message such as an electronic mail (email) message; a text message in accordance with a SMS-based or non-SMS based format; an instant message in accordance with Session Initiation Protocol (SIP); or a series of bits in accordance with another messaging protocol exchanged between software components or processes associated with these software components.

The term “interconnect” may be construed as a physical or logical communication path between two or more network devices. For instance, the communication path may include wired and/or wireless transmission mediums. Examples of wired and/or wireless transmission mediums may include electrical wiring, optical fiber, cable, bus trace, a radio unit that supports radio frequency (RF) signaling, or any other wired/wireless signal transfer mechanism.

The term “computerized” generally represents that any corresponding operations are conducted by hardware in combination with software and/or firmware. Also, the term “client” should be interpreted as a software component that is configured to be executed by one or more processors. The client may operate within either of the user or kernel modes of an operating system and may communicate (e.g., exchange data) with software applications or other logic modules. In some instances, a client may correspond to a driver operating in the user mode of the operating system of a network device.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

### II. Enterprise Environment Architectures

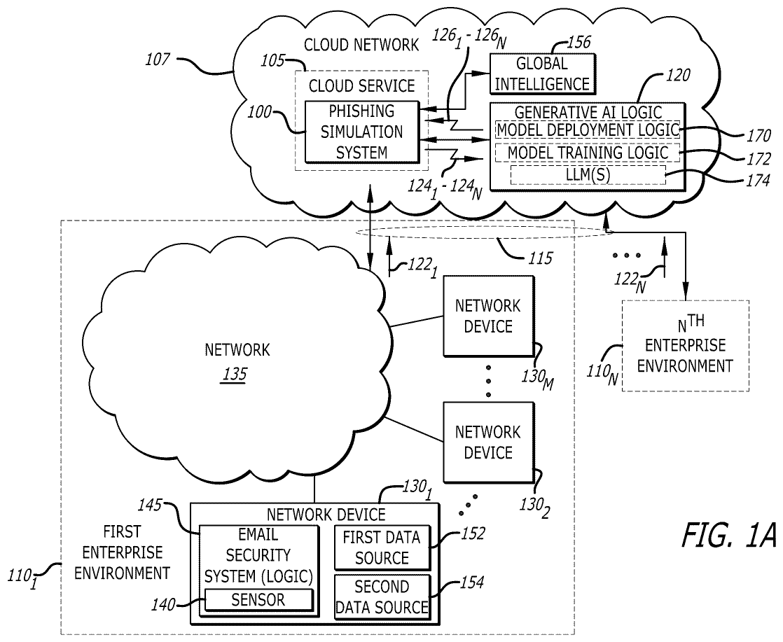

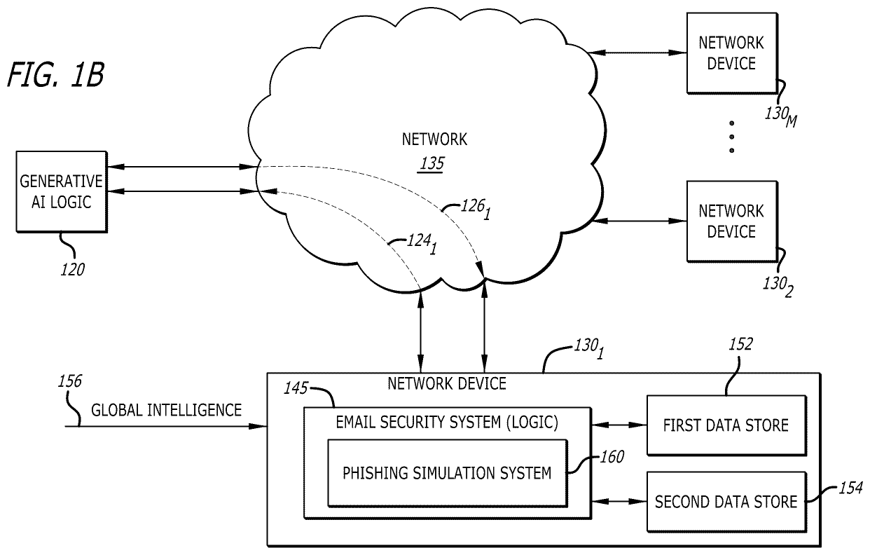

Referring to FIG. 1A, a block diagram of an exemplary embodiment of a phishing simulation system 100, operating as part of a cloud service 105 hosted by a cloud platform 107 (e.g., public cloud infrastructure provided by Microsoft Azure®, Amazon Web Services®, or Google Cloud®; private cloud infrastructure), is shown. According to this embodiment, the phishing simulation system 100 operates as a multi-tenant, Security-as-a-Service (SaaS), which is accessible by a plurality of tenants on demand 110-110_{N} (N≥1) (hereinafter, “enterprise environments” 110₁-110_{N}) over a transmission medium 115. The phishing simulation system 100 is communicatively coupled to generative AI logic 120, where the phishing simulation system 100 is adapted to receive content 122₁-122_{N} associated with each of the enterprise environments 110₁-110_{N} and generate prompts 124₁-124_{N} including at least a portion of the received content 122₁-122_{N}, respectively. In response to receipt of a prompt 124₁ . . . or 124_{N} (e.g., prompt 124₁), the generative AI logic 120 generates one or more training templates 126₁, which are customized and specific for the particular enterprise environment 110₁ that provided the content 122₁.

Herein, each enterprise environment 110₁-110_{N} pertains to a particular enterprise (e.g., company, partnership, co-op, governmental agency or other agencies, venture, etc.), such as a first enterprise environment 110₁ constitutes one or more network devices 130₁-130_{M} (M≥1) in communication with the cloud service 105 over a network 135 and corresponding interconnects. As shown, the first enterprise environment 110₁ features at least one sensor 140 (sensor(s)) that monitors communications over the network 135 from one of the network devices 130₁ . . . , or 130_{M} (M≥1) or between two or more of the network devices 130₁-130_{M}. Configured as part of email security system (logic) 145, the sensor 140 may be further configured to monitor behaviors or activities of network users of the network devices 130₂-130_{M}.

As further shown, the first enterprise environment 110₁ may include data stores 150, including a first data store 152 and a second data store 154. The first data store 152 is configured to retain data associated with the user behaviors and/or activities to generate one or more profiles directed to network users (e.g., employees, contractors, interns, volunteers, etc.) associated with the first enterprise environment 110₁, a profile for a group of users associated with the first enterprise environment 110₁ (e.g., users of a certain department, C-suite executives, etc.) and/or a profile for each user of the first enterprise environment 110₁ (hereinafter, generally referred to as a “enterprise profile(s),” where the user granularity may different between profiles). The second data store 154 is configured to retain data associated with prior attempted cyberattacks (e.g., attempted phishing attacks) within the first enterprise environment 110₁ (e.g., content from detected phishing emails collected by the enterprise-based sensors 140)

Referring still to FIG. 1A, the phishing simulation system 100 is adapted to receive global threat intelligence 156, which includes content pertaining to attempted cyberattacks collected by sensors across one or more industry sectors that are outside a particular enterprise environment (e.g., first enterprise environment 110₁ when training templates 126₁ are directed to phishing simulations conducted within the first enterprise environment 110₁). Both content from the first and second data stores 152 and 154, along with the global threat intelligence 156, may be used to generate customized training templates 126₁ for the first enterprise environment 110₁.

Referring now to FIG. 1B, a block diagram of an exemplary embodiment of a phishing simulation system 160 implemented within the network device 130₁ and operating as an on-premises (on-prem) deployment is shown. Herein, the phishing simulation system 160 is configured with similar functionality as the cloud-based phishing simulation system 100 of FIG. 1A, except that the phishing simulation system 160 is configured as a component of the email security system (logic) 145 of the first enterprise environment 110₁. The phishing simulation system 160 is adapted receive the content from the first and second data stores 152 and 154 along with the global threat intelligence 156, where the content is supplied as part of the prompt 124₁ or the content is accessible by the generative AI logic 120. As described above, the generative AI logic 120 may be used to produce one or more customized training templates 126₁ for the first enterprise environment 110₁.

Although not shown, the phishing simulation system may be deployed in a hybrid deployment in which a portion of the functionality associated with the phishing simulation system is implemented as a first phishing simulation subsystem within the cloud service 105 and the remainder of the functionality of the phishing simulation system is implemented as a second phishing simulation subsystem within the first enterprise environment 110₁.

Although not illustrated in detail, the generative AI logic 120 may be configured to perform various analytics on received messages. The generative AI logic 120 may include model deployment logic 170 and model training logic 172. The model deployment logic 170 is adapted to perform operations categorized as one or more artificial intelligence techniques. The model training logic 172 may perform operations to generate or train a machine learning model, where the model deployment logic 170 may perform operations to implement the trained machine learning model. As should be understood, machine learning is a subset of artificial intelligence (AI) that involves the development of algorithms and models that enable computers to learn and make predictions or decisions based on data, without being explicitly programmed. In essence, the goal of machine learning is to allow computers to improve their performance on a task over time by automatically learning from examples.

Alternatively, the generative AI logic 120 may be adapted with one or more large language models (LLM(s)) 174. The LLM(s) 174 operate by leveraging deep neural networks to process and generate human-like text. LLM(s) consist of multiple layers of interconnected neurons that transform input text into meaningful output. During operation, the LLM(s) 174 takes an input sequence of text, such as provided in a request message 252 as described below, and processes it through its layers, where each layer learns increasingly abstract features of the language. The LLM(s) 174 use attention mechanisms to focus on relevant parts of the input text and capture contextual information. Prior to deployment, the LLM(s) 174 may be pre-trained on a vast corpus of text, e.g., from the Internet, which imparts it with general language understanding, grammar, and world knowledge. After pre-training, the LLM(s) 174 may be fine-tuned for specific tasks, adapting its parameters to excel in various applications like generation of training templates as described below.

### III. Phishing Simulation System Infrastructure

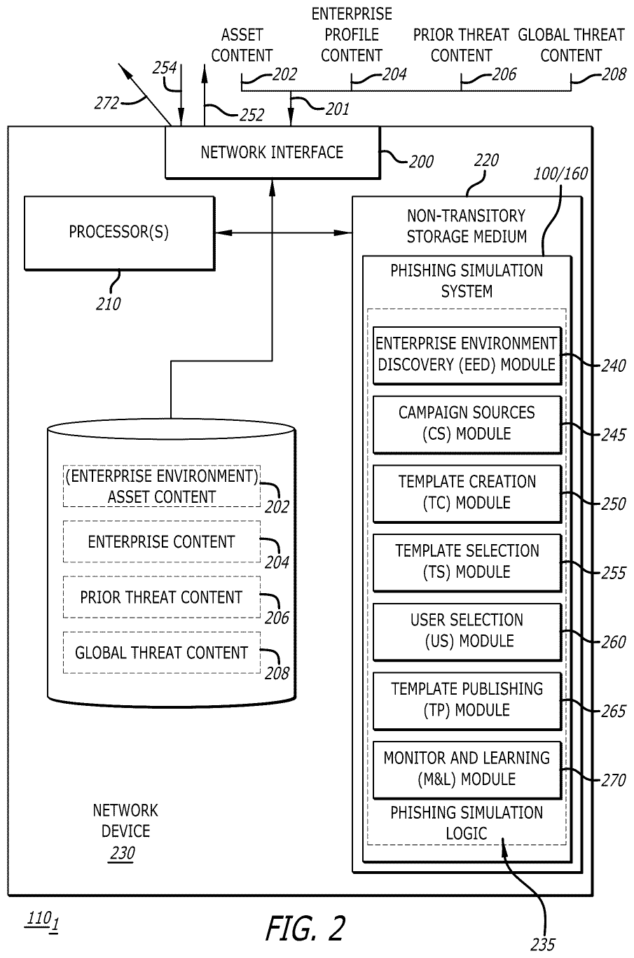

Referring now to FIG. 2, an exemplary block diagram illustrating an embodiment of an infrastructure of the phishing simulation system 100 of FIGS. 1A-1B is shown. Herein, the phishing simulation system 100 may be implemented as logic maintained within non-transitory storage medium 220 deployed within a network device 230 and executable by one or more processors 210 (hereinafter, “processor(s)”). For this embodiment, the network device 230 may be implemented as (i) network device 130₁ of FIG. 1B situated on-premises and coupled to the local network 135 or (ii) a network device hosting, at least in part, the cloud service 105 of FIG. 1A. Also, the processor(s) 210 may constitute one or more physical processors, one or more virtual processors (e.g., one or more software instances each operating as a processor), or a combination of physical and virtual processors. The non-transitory storage medium 220 may constitute physical memory, which may be implemented as part of the network device 130 or utilized by storage services (e.g., Amazon Simple Storage Service (S3), Google® Cloud Storage, Azure® Blob Storage, etc.) adapted to maintain the phishing simulation logic.

According to one embodiment of the disclosure, the network device 230 features a network interface 200, the processor(s) 210 and the non-transitory storage medium 220. The network interface 200 is adapted to receive enterprise content 201, which may include, but is not limited or restricted to one or more of the following: (1) content 202 associated with the enterprise environment assets (hereinafter, “asset content” 202), (2) content 204 associated with an enterprise profile, which may include content pertaining to networks users of the enterprise environment (hereinafter, “enterprise profile content” 204), (3) content 206 associated with prior attempted cyberattacks (e.g., phishing attacks) within the enterprise environment such as content from detected phishing emails collected by enterprise-based sensors (hereinafter, “prior threat content” 206), and/or (4) global threat intelligence including content pertaining to attempted cyberattacks collected by sensors across one or more industry sectors that are outside the enterprise environment (hereinafter, “global threat content” 208).

According to one embodiment of the disclosure, the asset content 202 may include information associated with hardware and/or software utilized within the first enterprise environment 110₁ (e.g., an enterprise network inclusive of the network device 230 operating as part of the enterprise network). The asset content 202 may include the types of software installed within the first enterprise environment 110₁. As an illustrative example, the asset content 202 may include information associated with software and/or hardware utilized by the enterprise, which may be further segmented into content associated with software and/or hardware utilized by certain departments, groups of users, or a particular user within the first enterprise environment 110₁.

For instance, the asset content 202 may include device identifiers associated with network devices deployed within the first enterprise environment 110₁, which identify the type or types of network devices installed within the first enterprise environment 110₁ (e.g., ‘M-10’ Dell® XPS® desktops, ‘5’ Dell® PowerEdge® XE9712 servers, ‘5’ Apple® MacBook Pro® laptops). The asset content 202 may further include information that identifies (i) the operating system (OS) types and/or versions run by the network devices (e.g., Windows® 11 OS, Windows® Server OS, Linux® OS, macOS®, etc.); (ii) types of software applications installed on the network devices (e.g., Abode® Acrobat® application for opening Portable Document Format (PDF) documents, Microsoft® Office for opening documents for word processing, Apple® Pages® for opening documents for word-processing, etc.); and/or (iii) software tools (e.g., user authentication software, video conferencing software such as Microsoft® Teams® or Zoom®, etc.) installed on the network devices within the first enterprise environment 110₁. The aggregate of the gathered asset content 202 may be stored as part of an enterprise profile 180 within the network device 130₁ (as shown) or within off-site storage.

Additionally, the enterprise profile content 204 includes information associated with users of the first enterprise environment 110₁ (e.g., employees, contractors, interns, volunteers, etc.), which may be received by the network interface 200 in response to query messages from the phishing simulation system 100 when the email security system (logic) 145 is remotely located from the phishing simulation system 100. Alternatively, the enterprise profile content 204 may be accessed through another interface, other than the network interface 200, when the email security system (logic) 145 is installed as part of the network device 230 and the phishing simulation system 100 is a component of the email security system (logic) 145.

The enterprise profile content 204 may include information concerning activities and/or behaviors of network users based on messages exchanged within the first enterprise environment 110₁. The activities and/or behaviors for the network users may be further segregated by each individual user or by one or more defined groups-by department (e.g., human resources, finance, engineering, legal, etc.), by role or rank (job title) within the first enterprise environment 110₁ (e.g., C-suite executives, managers, secretaries, etc.). Additionally, or in the alternative, the enterprise profile content 204 may include information concerning “vulnerable” network users (e.g., a group of users assigned with a vulnerability risk greater than or equal to a predetermined vulnerability risk level due to each user's behavioral history in failing to identify prior phishing simulations).

Furthermore, the network interface 200 may be configured to receive prior threat content 206, namely information associated with prior attempted cyberattacks within the first enterprise environment 110₁. The prior threat content 206 may include information associated with attempted phishing email messages detected and collected by enterprise-based sensors such as the email security system (logic) 145. Also, the network interface 200 may be configured to receive global threat content 208 corresponding to global threat intelligence that identifies attempted cyberattacks (e.g., phishing attacks) detected by sensors across one or more industry sectors and different geographic regions that are outside the first enterprise environment 110₁.

The enterprise content 201 is gathered and may be stored locally prior to be routed, during execution of the phishing simulation system 100 by the processor(s) 210, to one or more modules 235 forming the phishing simulation system 100 (hereinafter, the “phishing simulation logic 235”). The operability of the phishing simulation logic 235 is described below. In particular, the processor(s) 210 is adapted to execute the phishing simulation logic 235, which may include, but is not limited or restricted to an enterprise environment discovery (EED) module 240, a campaign sources (CS) module 245, a template creation (TC) model 250, a template selection (TS) module 255, a user selection (US) module 260, a template publishing (TP) module 265, and/or a monitor and learning (M&L) module 270.

More specifically, the EED module 240, when executed by the processor(s) 210, is adapted to discover and identify enterprise environment assets. For this embodiment, the EED module 240 may generate and provide messages that perform scanning of network devices deployed within the first enterprise environment 110₁. As an illustrative example, the EED module 240 may initiate request messages to one or more sensors, such as the email security system (logic) 145 for example. Deployed within the network device 230 or remotely therefrom, the email security system (logic) 145 collects the asset content 202 from email messages propagating across the first enterprise environment 110₁. The asset content 202 may include information pertaining to hardware forming the infrastructure of the first enterprise environment 110₁ and software maintained and/or processed by the hardware within the first enterprise environment 110₁. As described above, the software may include software applications and/or software tools for example.

For instance, the EED module 240 may be adapted to determine the OS types supported by the network devices within the first enterprise environment 110₁, where at least a portion of the asset content 202 may be available to the TC module 250 for routing to the generative AI logic 120. As a result, the asset content 202 is intended to assist in the selection and customization of the training templates by the generative AI logic 120 to target certain network devices having a particular OS type within the first enterprise environment 110₁.

As another example, the EED module 240 may be adapted to identify authentication protocols, where the content associated with the identified authentication protocol may be utilized to generate a customized training template having a link to a simulated authentication login page pertaining to the identified authentication protocol. As yet another example, the EED module 240 is adapted to identify a type of video conferencing application normally utilized by users within the first enterprise environment 110₁, where the content may be used to generate training templates that represent email messages to supposedly access the identified video conferencing application.

The CS module 245 is adapted to obtain content associated with relevant phishing campaigns performed on both a global basis and a local basis. More specifically, the CS module 245 is adapted to obtain the prior threat content 206 from a network device deployed within the first enterprise environment 110₁, such as the email security system (logic) 145 of FIGS. 1A-1B. The prior threat content 206 includes information pertaining to observed phishing attacks directed to the first enterprise environment 110₁, where the phishing attacks may have been blocked by the email security system (logic) 145.

The CS module 245 is further adapted to obtain the global threat content 208, namely information associated with phishing attacks observed globally across multiple enterprise environments 110₁-110_{N}, where the information associated with these phishing attacks may be sorted by industry, geographic location, language, targeted software, time of activity, or the like. At least a portion of the threat content 206/208 may be available to the TC module 250 for inclusion in message(s) routed to the generative AI logic 120 for subsequent generation of a customized training template directed to the first enterprise environment 110₁.

Referring still to FIG. 2, the TC module 250 is communicatively coupled to the EED module 240 and the CS module 245. The TC module 250 is configure to use at least a portion of the asset content 202, the prior threat content 206, and/or global threat content 208 to generate a request message 252 (e.g., prompt) to the generative AI logic, which creates and returns one or more training templates 254 customized for the first enterprise environment 110₁ and/or network users of the first enterprise environment 110₁. It is contemplated that the enterprise profile content 204 may be utilized by the TC module 250 to generate the enterprise-specific training templates 254, although the enterprise profile content 204 may be utilized by the US module 260 as described below.

More specifically, the TC module 250 performs operations on the content from the CS module 245 by removing personal identifiable information (PII) data and “non-usable” data from the prior threat content 206 and/or the global threat content 208 (generally, “threat content 206/208’) prior to utilizing at least a portion of the threat content 206/208 in generation of the request message 252. The “non-usable” data constitutes data that is too specific to a person or enterprise/entity, where the removal of the non-usable data generalized the threat content 206/208 to assist in generation of a training template that is more useful by multiple enterprises. As an illustrative example, portions of the prior threat content 206/208 may be inserted as data within the request message 252 to customize the training template(s) 254. Alternatively, information may be added to the request message 252 to enable the generative AI logic 120 of FIG. 1A or FIG. 1B to access at least a portion of the threat content 206/208 maintained within the network device 230.

Additionally, the TC module 250 may be configured to add customizations to identify a specific enterprise or targeted group or user role to generate a further customized the training template(s) 254. For instance, the TC module 250 may identify one or more group parameters (e.g., human resources, finance, information technology, etc.) and/or user role parameters (e.g., manager, director, clerk, etc.) targeted for phishing simulation. For such customization, the TC module 250 may be further adapted to extract group and/or user role parameters from the enterprise profile content 204 to assist the generative AI logic 120 and the security administrator to produce customize training templates that are specific to a particular enterprise (e.g., the first enterprise environment 110₁).

As further shown in FIG. 2, the TS module 255 is configured to utilize data from the EED module 240 to select a phishing simulation for an enterprise based on detected enterprise environment assets identified in the asset content 202. In particular, the TS module 255 may utilize portions of the asset content 202 in order to select the training template 254 for the first enterprise environment 110₁. In addition, the TS module 255, in customizing the training template 254, is adapted to consider specific events that may occur within a predetermined time period scheduled for the phishing simulation and modify the training template 254 accordingly. For example, if the train template 254 is associated with a phishing simulation for the Finance department set to occur at the end of the month, the TS module 255 may be adapted to further “tune” (modify) the training template 254 to simulate a phishing email message seemingly directed to a finance operation that, based on prior emails monitored by the email security system (logic) 145, typically occurs at the end of the month such as request for electronic payments, request for accounts receivable information between network users, or the like.

The US module 260 is configured to target certain groups of network users associated with an enterprise environment (e.g., the first enterprise environment 110₁) based on one or more user parameters. For instance, the US module 260 may be configured to select a training template from the training template(s) 254 or reconfigure a training template from the training template(s) 254 to conduct a role-based phishing simulation in which network users associated with a particular role are targeted. Additionally, or in the alternative, the US module 260 may be configured to select a training template from the training template(s) 254 or automatically reconfigure a training template from the training template(s) 254, without user interaction, to conduct a phishing simulation targeting a certain group such as a particular department, team within the department, or even C-suite executives of the first enterprise environment 110₁.

Additionally, or in the alternative, the US module 260 may be configured to select a training template from the training template(s) 254 or reconfigure a training template from the training template(s) 254 based behavioral history of a certain group of users who may have different roles or work in different departments. Additionally, the US module 260 may be configured to select and/or reconfigure a training template for generating phishing email messages with certain phishing artifacts that the grouped network users have failed to identify, in a prior phishing simulation, as an indication that an incoming email is a simulated phishing email message. The assignment of the group of users may be broadly directed to any network users who failed a prior phishing simulation or may be narrowly tailored to a group of network users who are deemed by the phishing simulation system 100 as vulnerable to particular type of phishing attack that is prevalent in the threat landscape (e.g., credential-based phishing attack, a link-based phishing attack, an attachment-based phishing attack, etc.) based on behavior activity in prior phishing simulation(s).

Referring still to FIG. 2, the TP module 265 is configured to provide the customized training template, produced by the TS or US modules 255/260 for the first enterprise environment 110₁, available to a security administrator of the first enterprise environment 110₁ to conduct a phishing simulation. The TP module 265 is adapted to allow further customization of the training template 254 to suit a specific user selection or a specific user group in accordance with determinations made by the US module 260.

The M&L module 270 is adapted to create a notification 272, such as a web page or pop up, to identify when the enterprise has successfully completed a phishing simulation and/or one or more network users have failed a phishing simulation. With respect to failure of a phishing simulation, the M&L module 270 may be adapted to generate and/or provide training materials (e.g., summary, video, etc.) to identify to a network user different aspects in a simulated phishing email message that should have provided a hint to the network user that a received email message was associated with a potential phishing attack. Based on preferences by the enterprise, the M&L module 270 may be a further adapted to generate a message query from the security administrator as to user availability to conduct a training session to go over the training materials and/or generate a calendar appointment for the training session (e.g., Outlook® calendared appointment), which may be identify a location for a physical meeting or may include a video conferencing link.

The M&L module 270 is further configured to conduct analytics on the results of the phishing simulation to determine a failure rate and a success rate to be provided to the security administrator. The “failure rate” is a measure of a percentage or number of network users who fell for a simulated phishing attack. This typically involves actions like clicking on a link, downloading an attachment, entering credentials in a fake login page, or the like. Conversely, the “success rate” is a measure of a percentage or number of network users who successfully identified and reported a simulated phishing emails during the phishing simulation. Additionally, the analytic results may be provided to the generative AI logic 120 of FIGS. 1A-1B to train AI models within the generative AI logic 120 to provide training templates that may focus more on those particular phishing simulation aspects with a failure rate exceeding a predetermined threshold.

### IV. Exemplary Workflow of the Phishing Simulation System (Logic)

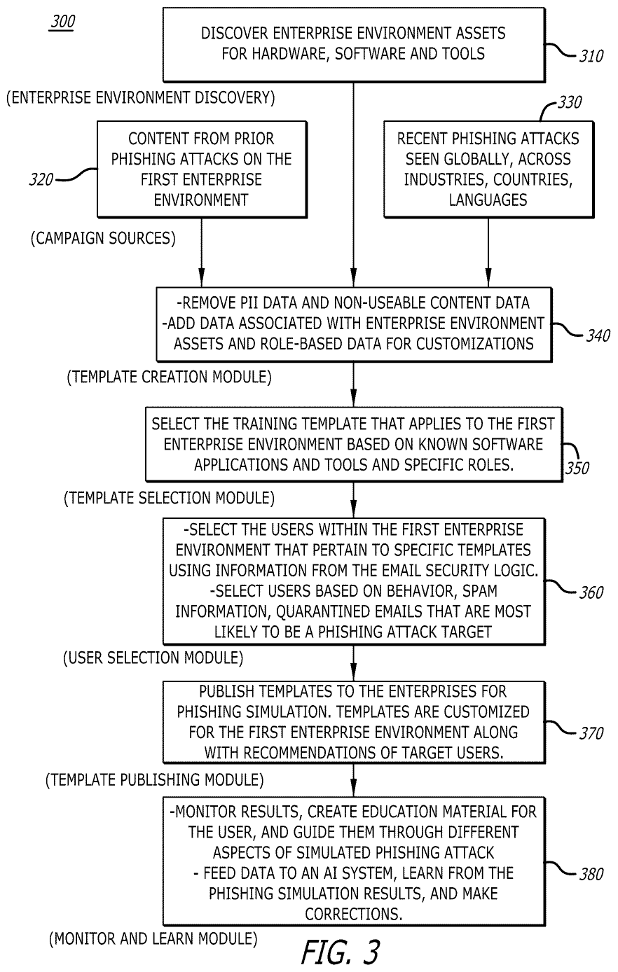

Referring now to FIG. 3, a flow chart diagram illustrating a process 300 conducted by the phishing simulation system 100 of FIGS. 1A-2, which leverages generative AI logic to generate training templates used to formulate simulated phishing email messages is shown. First, the process 300 conducts operations to discover and collect content associated with the enterprise environment assets, such as one or more parameters that identify the hardware and software infrastructures forming the first enterprise environment (block 310). The content associated with the enterprise environment assets is provided to logic (e.g., template creation (TC) module) along with content associated with prior phishing attacks (blocks 320 and 330).

Herein, the content associated with prior phishing attacks includes information associated with prior phishing attacks conducted on the first enterprise environment (e.g., blocked phishing e-mail campaigns directed to the first enterprise environment) and/or information associated with phishing attacks being conducted globally on other enterprise environments. The information associated with the global phishing attacks may be selected based on industry, geographic region, language, or other characteristics that can be used to categorize the different global phishing attacks.

Thereafter, the process 300 (e.g., TC module) is responsible for creating a prompt to be provided to the generative AI logic to create a training template that is customized for the first enterprise environment (block 340). More specifically, the prompt may be based, at least in part, on the enterprise environment assets and the information associated with the local and/or global phishing attacks. This PII data and non-usable content within information associated with the local and/or global phishing attacks is removed, where data (e.g., parameters) associated with the enterprise environment assets and role-based data associated with the enterprise profile are added for customization of the training templates considering the hardware and/or software infrastructures supported by the first enterprise environment.

In response to the prompt being sent to the generative AI logic and one or more training templates being returned, the process is configured to determine which of the training templates apply to the first enterprise environment based on known software applications and tools and specific organization hierarchies and user roles supported by the first enterprise environment (block 350).

Next, after one or more training template produced by the generative AI logic has been selected, the user selection (US) module, namely an AI-driven module, is configured to select the network users within the first enterprise environment that pertain to the selected training template(s) (block 360). This user selection may involve usage of information from one or more sensors, located in the first enterprise environment such as the e-mail security system (logic) for example, to select a specific user or groups of a number of user-based factors.

For instance, the user selection may be directed to user(s) with a particular role (e.g., involved in accounts payable processing, involved in legal counsel for the enterprise, etc.) or with a particular title (e.g., manager, director, clerk, secretary, etc.). Additionally the user selected may be based on behavior of the users such as those users that have been vulnerable to prior phishing email campaigns, failed prior phishing simulations, maintain a number of unreported (and opened) simulated phishing email images in their inbox - factors that suggest these user will most likely to be a targeted user for a potential phishing attack.

Thereafter the training templates are published for usage by the security administrator in conducting a phishing simulation (block 370). The security administrators associated with the enterprise environment are now responsible for further customizing the training templates, based on recommendations by the user selection module as to the targeted users.

Thereafter, the results of the phishing simulation are monitored, where education materials are generated to provide learning assistance for those users who failed the phishing simulation (block 380). The education materials may include a message with a link to a web page (i.e., learning page) to guide the user through different aspects of a phishing attack, and thereby assist the users in identifying future phishing email messages. The results are further provided to the generative AI logic for training purposes, where the results may assist LLMs and/or AI models in making appropriate adjustments in the generation of future training templates to concentrate on certain features or aspects of the simulated phishing email message that were not recognized by the user or users. Additionally, users may be notified as to successful or failed phishing simulation activities, where additional training may be initiated by the phishing simulation system to invite and/or calendar the additional training sessions.

### V. GUI Representations

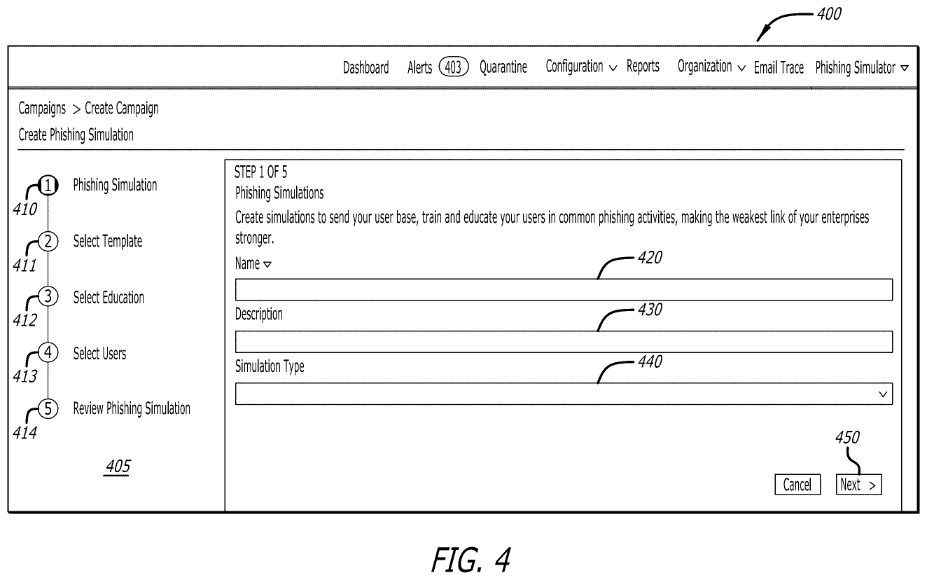

Referring now to FIG. 4, a graphic user interface (GUI) 400 illustrating operations conducted to perform the AI-based phishing simulation is shown. Herein, the GUI 400 indicates a sidebar 405 that features icons 410-414 each corresponding to a phase of a multi-phase process conducted to perform the phishing simulation. These phases 410-414 include (i) a first phase 410 for identifying the phishing simulation, (ii) a second phase 411 for selecting training templates associated with the phishing simulation, (iii) a third phase 412 for selecting education materials and the presentation of such materials for the phishing simulation, (iv) a fourth phase 413 for selecting network users targeted by the phishing simulation, and (v) a fifth phase 414 for reviewing the phishing simulation particulars prior to publication and transmission to the users. The operability of these phases 410-414 may be selected by a security administrator of an enterprise environment desirous to perform phishing simulations (e.g., first enterprise environment 1101 of FIGS. 1A-1B.

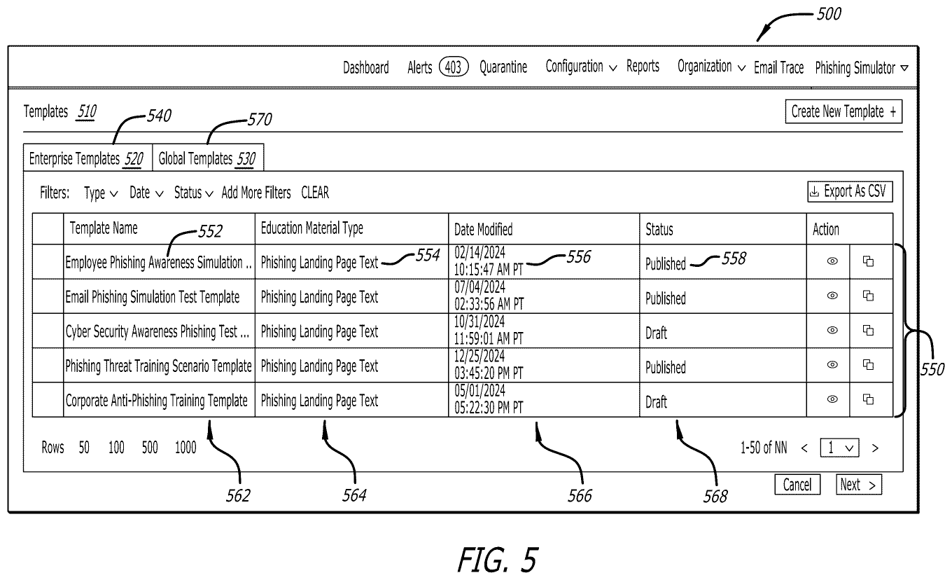

With respect to the first phase 410, as shown in FIG. 4, the GUI 400 includes a first entry 420 for selecting an identifier for the phishing simulation (e.g., name), where the phishing simulation may be stored with a data store upon publication and utilized to harden security associated with the first enterprise environment. The GUI 400 further includes a second entry 430 adapted to enable the security administrator to identify and describe the targeted purpose behind the phishing simulation. A third entry 440 in the GUI 400 is to identify the simulation type such as a credential-based phishing attack, a link-based phishing attack, an attachment-based phishing attack, or the like. Upon formulation of the identification information for the phishing simulation, upon selection of the ‘Next’ display element 450, additional GUIs are provided, such as a second GUI 500 that allows the security administrator to select one or more training templates to use in the phishing simulation. Illustrative training templates 510 are shown in FIG. 5.

Referring now to FIG. 5, the second GUI 500 is shown, where the training templates 510 produced by the generative AI logic 120 of FIGS. 1A-1B may be categorized as ‘enterprise’ templates 520 and ‘global’ templates 530. Upon selection of a first tab 540 illustrated as a first display element of the second GUI 500, one or more training templates 550 formulated for the first enterprise environment are listed. Each of the training template(s) 550 may be represented in accordance with template name 552, education material type 554, modification date 556, and/or status 558 (e.g., “published” (in operation) or “draft” (awaiting completion).

In particular, for this embodiment, the template name 552 is illustrated in a first column 562 while the education material type 554 is identified in a second column 564. As shown, the education material type 554 represents that a web page (phishing landing page) will be utilized as supplemental education material for a targeted group or user in response to a failure of the phishing simulation. The third column 566 identifies the modification date 556 corresponding to the last time a corresponding training template was modified. The fourth column 568 identifies the status 558 of the phishing simulation, which indicates whether the training templates are in a ‘Published’ state (available for use by a security administrator for the first enterprise environment) or a ‘Draft’ state in which the training template has not been fully completed for use by the security administrator.

Upon selection of a second tab 570 illustrated as a second display element of the second GUI 500, one or more global training templates formulated for use by a plurality of enterprise environments, including the first enterprise environment, are listed in a manner similar to that illustrated for the enterprise training templates.

Returning back to FIG. 4, upon completion of the second (training template selection) phase 411, education materials and the presentation of such materials for the phishing simulation may be selected from a GUI (third phase 412). Although not shown, the third phase 412 (education material and presentation phase) may involve the generation of a GUI to allows a security administrator to select a notification and supplemental training scheme for network users who have failed the phishing simulation. This scheme may include the notification type and the supplemental training type.

For example, one type of notification may include the transmission of a notification message to a user failing the phishing simulation, where the notification message conveys to the targeted user(s) that a phishing simulation was conducted and provides the user(s) with the results of the phishing simulation or access to the results. Where the targeted user(s) has failed the phishing simulation, the notification message may be selected to include (i) a URL link to a web page that identifies a listing of aspects that were present in the simulated phishing email message but missed by the user and/or (ii) one or more URL links to supplemental training materials (e.g., videos, slides, etc.) that can be reviewed by the user. Additionally, or in the alternative, the notification message may be selected as a calendar appointment invite for a scheduled training session to ensure that the user is more informed as to differentiate between an authentic email message and a phishing email message.

Upon selection of and completion of the education notification, the targeted network users targeted for the phishing simulation are selected (fourth phase 413). This phase allows the security administrator to conduct different types of group-based phishing simulations, where the grouping may constitute role-based phishing simulation or rank(title)-based phishing. The ‘role-based’ phishing may have different granularities, ranging from enterprise-level roles that may be determined from department type (e.g., accounting, human resources, engineering, legal, etc.) to user-level roles (e.g., accounts payable within accounting, accounts receivable within accounting, resource procurement within engineering, etc.). Based on the type of network user(s) selected, the simulated phishing email messages based on training templates are structured toward these targeted user(s), deviating from a standard email format that may be more easily seen as being not applicable to the targeted user(s).

Lastly, after the targeted network users have been selected, during the fifth phase 414, although not shown, a GUI is generated to enable the security administrator to further review and modify the training template being part of a simulated phishing email message to comport with internal or external email format (e.g., add logo, etc.) to visually ensure that the simulated phishing email messages accounts for additional email structures that may not have been fully captured by the generative AI logic.

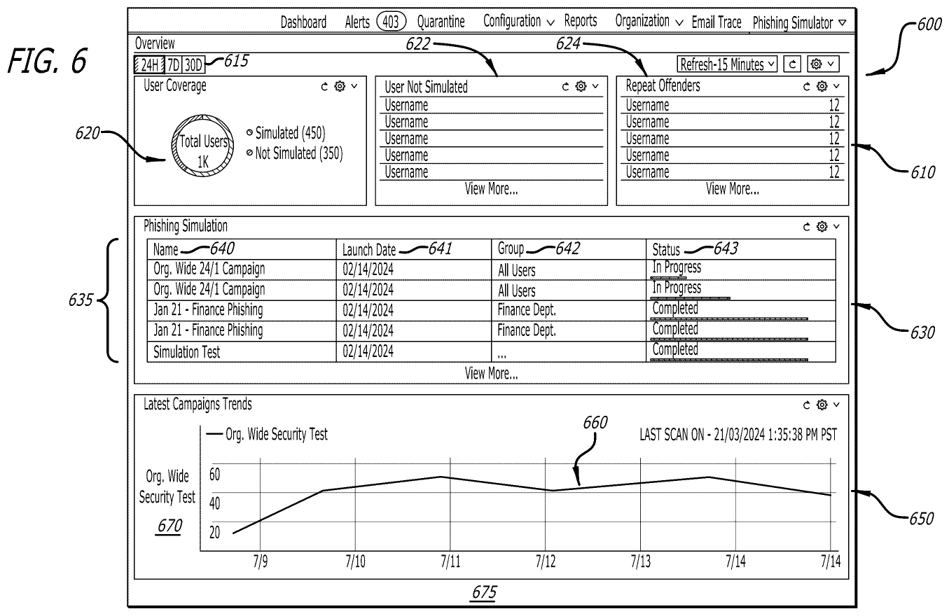

Referring now to FIG. 6, a GUI dashboard 600 is illustrated. The GUI dashboard 600 includes a first region 610, a second region 630, and a third region 650. The first region 610 is directed toward the conveyance of user metrics. For example, upon selection of a prescribed time period (e.g., day, week, month, etc.), a first user metric 620 may feature a representation of the number of network users associated with an enterprise environment who have been targeted for phishing simulation. The first user metric 620 may further identify the total number of users associated with the enterprise environment (total users) and the number of users who have not been targeted for phishing simulation yet. Another (second) user metric 622 may include a listing of the users who have not been targeted for phishing simulation and a third user metric 624 including a listing of users who have failed the phishing simulation. It is contemplated that the user listing may order the users based on the number of failed phishing simulations to identify repeat offenders to ensure that security administrators target future phishing training on these users.

As still shown in FIG. 6, the second region 630 of the GUI dashboard 600 is directed towards a listing of phishing simulations 635 that are being conducted (‘In Progress’) or have been completed (‘Completed’). The phishing simulations 635 may be identified by name 640, launch date 641, targeted group 642, and status 643 (e.g., ‘In Progress’ or ‘Completed’)

Third region 650 of the GUI dashboard 600 is directed toward a graphical depiction of phishing simulations trending 660, which represents the number of phishing simulation (y-axis) 670 conducted over a prescribed period of time (x-axis) 675. This information provides evidence of the degree of security protections conducted by the enterprise for the enterprise environment, which may be useful in the event that a phishing attack is successful, and the enterprise needs to publicly report the security breach and provide evidence that adequate security measures were undertaken prior to the security breach.

In the foregoing description, the invention is described with reference to specific exemplary embodiments thereof. It will, however, be evident that various modifications and changes may be made thereto without departing from the broader spirit and scope of the invention as set forth in the appended claims.

What is claimed is:

1. A network device, comprising:
a processor; and
a non-transitory storage medium communicatively coupled to the processor, the non-transitory storage medium comprises
an enterprise environment discovery module configured, upon execution by the processor, to obtain content associated with environment assets situated within a first enterprise environment;
a campaign source module configured, upon execution by the processor, to obtain content associated with phishing campaigns performed locally within the first enterprise environment and globally within one or more enterprise environments; and
a template creation module configured, upon execution by the processor, to generate a request message, including at least a portion of the content associated with the environment assets and the content associated with the phishing campaigns, for transmission to generative AI logic adapted to create and return one or more training templates customized for the first enterprise environment.

2. The network device of claim 1, wherein the non-transitory storage medium further comprises:
a template selection module configured, upon execution by the processor, to utilize data from the enterprise environment discovery module to select a training template of the one or more training templates for usage in a phishing simulation for the first enterprise environment.

3. The network device of claim 2, wherein the non-transitory storage medium further comprises:
a user selection module configured, upon execution by the processor, to select the training template from the one or more training templates to conduct a role-based phishing simulation in which a selected group of network users associated with a particular role are targets for the phishing simulation.

4. The network device of claim 3, wherein the non-transitory storage medium further comprises:
a monitor and learning module configured, upon execution by the processor, to generate a notification to identify when the phishing simulation has completed and identification of any network users having failed the phishing simulation.

5. The network device of claim 4, wherein the monitor and learning module is further configured, upon execution by the processor, to provide training materials to identify to a network user different aspects in a received email message of the phishing simulation that should have provided a hint to the network user that the received email message was associated with the phishing simulation.

6. The network device of claim 5, wherein the monitor and learning module is further configured, upon execution by the processor, to generate a message query as to user availability to conduct a training session to go over the training materials or generate a calendar appointment for the training session.

7. A method comprising:
obtaining content associated with environment assets situated within a first enterprise environment;
obtaining content associated with phishing campaigns performed locally within the first enterprise environment and globally within one or more enterprise environments; and
generating a request message, including at least a portion of the content associated with the environment assets and the content associated with the phishing campaigns, for transmission to generative AI logic adapted to create and return one or more training templates customized for the first enterprise environment.

8. The method of claim 7 further comprising:
utilizing data from an enterprise environment discovery module that obtain the content associated with the environment assets to select a training template of the one or more training templates for usage in a phishing simulation for the first enterprise environment.

9. The method of claim 8 further comprising:
selecting the training template from the one or more training templates to conduct a role-based phishing simulation in which a selected group of network users associated with a particular role are targets for the phishing simulation.

10. The method of claim 9 further comprising:
generating a notification to identify when the phishing simulation has completed and identification of any network users having failed the phishing simulation.

11. The method of claim 8 further comprising:
providing training materials to identify to a network user different aspects in a received email message of the phishing simulation that should have provided a hint to the network user that the received email message was associated with the phishing simulation.

12. The method of claim 11 further comprising:
generating a message query as to user availability to conduct a training session to go over the training materials or generate a calendar appointment for the training session.

13. A non-transitory storage medium including software that, when executed by a processor, generating one or more training templates to detect a phishing campaign, the software comprising:
an enterprise environment discovery module configured, upon execution by the processor, to obtain content associated with environment assets situated within a first enterprise environment;
a campaign source module configured, upon execution by the processor, to obtain content associated with phishing campaigns performed locally within the first enterprise environment and globally within one or more enterprise environments; and
a template creation module configured, upon execution by the processor, to generate a request message, including at least a portion of the content associated with the environment assets and the content associated with the phishing campaigns, for transmission to generative AI logic adapted to create and return one or more training templates customized for the first enterprise environment.

14. The non-transitory storage medium of claim 13, wherein the software further comprises:
a template selection module configured, upon execution by the processor, to utilize data from the enterprise environment discovery module to select a training template of the one or more training templates for usage in a phishing simulation for the first enterprise environment.

15. The non-transitory storage medium of claim 14, wherein the software further comprises:
a user selection module configured, upon execution by the processor, to select the training template from the one or more training templates to conduct a role-based phishing simulation in which a selected group of network users associated with a particular role are targets for the phishing simulation.

16. The non-transitory storage medium of claim 15, wherein the software further comprises:
a monitor and learning module configured, upon execution by the processor, to generate a notification to identify when the phishing simulation has completed and identification of any network users having failed the phishing simulation.

17. The non-transitory storage medium of claim 16, wherein the monitor and learning module is further configured, upon execution by the processor, to provide training materials to identify to a network user different aspects in a received email message of the phishing simulation that should have provided a hint to the network user that the received email message was associated with the phishing simulation.

18. The non-transitory storage medium of claim 17, wherein the monitor and learning module is further configured, upon execution by the processor, to generate a message query as to user availability to conduct a training session to go over the training materials or generate a calendar appointment for the training session.
